(19) United States
(12) Patent Application Publication
(10) Pub. No.: US 2020/0309181 A1
(43) Pub. Date: Oct. 1, 2020

(54) Fastener Device

(71) Applicant: Buzz Bee Toys (HK) Co., Limited, Kowloon (HK)

(72) Inventor: Chor-Ming Ma, Kowloon (HK)

(21) Appl. No.: 16/365,793

(22) Filed: Mar. 27, 2019

(51) Int. Cl. F16B 21/08; F16B 21/06; F16B 5/06

(52) U.S. Cl. CPC F16B 21/08; F16B 2200/20; F16B 5/0685; F16B 21/065

(57) ABSTRACT

The invention relates to a fastener device for connecting an article to a sheet-form material. The fastener device comprises a part for attaching to the article. The fastener device includes a fastener member for holding said sheet-form material in a fixed position relative to the fastener device such that a first side surface of the sheet-form material faces the article. The fastener member is pivotally movable from an open position to a fastening position to contact with a second, opposing side surface of the sheet-form material to hold said sheet-form material in said fixed position. A method of using the fastener device comprises attaching a part of the fastener device to the article and inserting a part of the fastener device into an aperture of the sheet-form material from a first side surface of the sheet-form material. The method includes pivotally moving the fastener member of the fastener device from an open position to a fastening position to contact with a second, opposing side surface of the sheet-form material to hold said sheet-form material in a fixed position relative to the fastener device.

### FIELD OF THE INVENTION

The invention relates to a fastener device, and particularly, but not exclusively, to a fastener device for connecting an article such as a toy to a sheet-form material such as a packaging material.

### BACKGROUND OF THE INVENTION

FIG. 1 shows a known fastener device 10 for fastening an article such as a toy to a sheet-form material such as a packaging material, e.g. a cardboard sheet or the like, for shipment and display of the toy. The fastener device 10 comprises a screw-threaded pin 12 extending upwardly (as viewed in FIG. 1) from a broad, round, planar base part 14.

A method of using the known fastener device 10 of FIG. 1 is shown in FIG. 2. The method comprises introducing the pin 12 into an aperture 18 in the sheet-form packaging material 20 from an underside 20A of the packaging material (as viewed in FIG. 2). The aperture 18 is sized to have a diameter which is larger, but closely fitting with a diameter of the pin 12. Once a sufficient portion of the pin 12 is inserted through the aperture 18, an upper screw-threaded portion 12A of the pin 12 is screw-threadedly engaged with a screw-threaded hole 24 or the like provided in a wall 26 of the toy 28. The fastener device 10 is rotated to fully screw-threadedly engage the fastener device 10 to the toy 28 thereby fixing the packaging material 20 between an upper surface 14A of the planar base part 14 of the fastener device 10 and a bottom surface 28A of the toy 28.

FIG. 3 shows another known fastener device 30 which differs from the fastener device 10 of FIG. 1 in that, although it has a same broad, round, planar base part 34, it comprises a pin 32 having a bayonet type connector for engaging a hole in a toy instead of having a screw-threaded pin. The method of using the fastener device 30 of FIG. 3 is largely the same as that described with respect to FIG. 2 for the fastener device 10 of FIG. 1 but where a lesser amount of rotation of the fastener device 30 compared to the screw-threaded fastener device 10 of FIG. 1 will engage the bayonet type pin 32 in the hole of the toy. The fastener device 30 of FIG. 3 is, however, less secure in fixing the position of the packaging material relative to the fastener device and the toy than is the case with the screw-threaded fastener device 10 of FIG. 1.

The known fastener devices of FIGS. 1 and 3 present a number of problems.

The method described with respect to FIG. 2 requires that a human operator or machine manipulating an article such as a toy 28 to be connected to a sheet-form packaging material 20 using one of the known fastener devices 10, 30 must first insert the pin 12, 32 of the fastener device 10, 30 through the aperture 18 in the packaging material before attaching the article such as a toy 28 to the fastener device 10, 30. This requires three holding positions, one each for the toy 28, the packaging material 20 and the fastener device 10, 30. Also, this method increases the likelihood of scoring or damage occurring to printed product art/advertising/information on a toy facing surface 20B of the packaging material 20.

Furthermore, typically the pins 12, 32 of such fastener devices 10, 30 have a diameter of about 3 mm to 5 mm. The aperture 18 in the sheet-form packaging material 20 has a diameter slightly larger than 3 mm to 5 mm to smooth insertion of the pin 12, 32 through the aperture 18. Consequently, whilst there is reasonable connection strength of the toy 28 to the fastener device 10, 30 and the packaging material 20 in a longitudinal direction of the pin 12, 32, there is little transverse strength in the connection such that the pin 12, 32 is susceptible to shearing off at the planar base part 14, 34. This typically occurs during transportation of packaged toys 28 where rough handling of the packaged toys 28 may bring the weight of the toy 28 to bear transversely on the pin 12, 32 causing it to shear off and/or damage the packaging material around the aperture 18, e.g. causing a tear in the packaging material 20 at the location of the aperture 18. A further problem is that the packaged toy 28 may itself be damaged by such rough handling if the pin 12, 32 shears off. Yet a further problem is that, by the time the packaged toy is ready to be displayed in a store, the toy 28 and/or the packaging material 20 may have been damaged as described above and the packaged toy 28 will not be in a suitable condition for presentation to consumers to view.

In view of the foregoing, there is a need for an improved method of packaging articles such as toys and an improved fastener device for doing so.

### OBJECTS OF THE INVENTION

An object of the present invention is to provide an improved fastener device for connecting an article to a sheet-form material.

Another object of the invention is to provide an improved method of connecting articles to sheet-form packaging material.

Another object of the present invention is to mitigate or obviate to some degree one or more problems associated with known fastener devices, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a fastener device for connecting an article to a sheet-form material. The fastener device comprises a part for attaching to the article. The fastener device includes a fastener member for holding said sheet-form material in a fixed position relative to the fastener device such that a first side surface of the sheet-form material faces the article. The fastener member is pivotally movable from an open position to a fastening position to contact with a second, opposing side surface of the sheet-form material to hold said sheet-form material in said fixed position.

In a second main aspect, the invention provides a method of using the fastener device of the first aspect of the invention, the method comprising attaching the fastener device to the article and then inserting part of the fastener device into an aperture of the sheet-form material from a first, upper side surface of the sheet-form material. The method includes pivotally moving the fastener member of the fastener device from an open position to a fastening position to contact with a second, opposing under-side surface of the sheet-form material to hold said sheet-form material in a fixed position relative to the fastener device and the article being packaged.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 shows a known fastener device;

FIG. 2 illustrates a method of using the known fastener device of FIG. 1;

FIG. 3 shows another known fastener device;

FIG. 4 is a side view of a first embodiment of a fastener device in accordance with the invention;

FIGS. 5A to C are respectively a first side view, a second side view and a bottom view of a second embodiment of a fastener device in accordance with the invention;

FIG. 6 shows a series of steps for connecting a fastener device according to any of the embodiments of the invention to an article and sheet-form packaging material in accordance with a first method of the invention;

FIG. 7 shows a series of steps for connecting a fastener device according to some embodiments of the invention to an article and sheet-form packaging material in accordance with a second method of the invention;

FIGS. 8A to E are respectively a perspective view, a first side view, a second side view, a top view and a bottom view of a third embodiment of a fastener device in accordance with the invention;

FIG. 9 shows a series of steps for connecting the fastener device of FIGS. 8A to E to an article and sheet-form packaging material in accordance with a third method of the invention; and

FIG. 10 illustrates the two main steps of all of the methods of the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

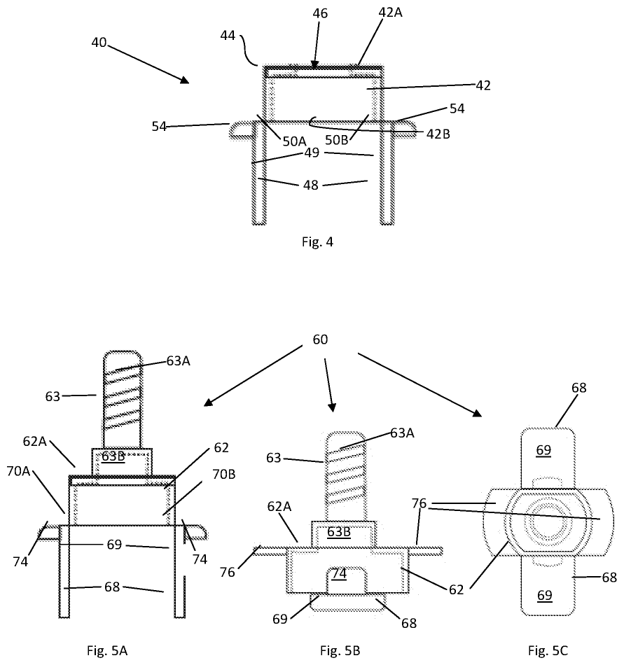

FIG. 4 is a side view of a first embodiment of a fastener device 40 in accordance with the invention. The fastener device 40 is configured to enable an article such as a toy to be connected or attached to a sheet-form material such as packaging material. The sheet-form packaging material may comprise cardboard or any sheet-form material suitable for packaging a toy or the like for shipping and/or presentation at a point of sale. The fastener device 40 comprises a a head portion 42 for attaching to the article. An upper surface 42A of the head portion 42 may be adhered or glued to a surface of the article. The upper surface 42A may be provided with a self-adhering layer 44 or double-sided adhesive tape to facilitate easy attachment of the fastener device 40 to the article. In another arrangement, the head portion 42 may alternatively or additionally have a central aperture 46 through which a screw, rivet, post or the like can be manually or machine inserted for engaging a hole provided in the article by screwing, riveting, friction fit or the like. The connection between the head portion 42 and the article may even comprise a snap fit connector.

The fastener device 40 has at least one, but preferably two, fastener members 48 for holding the sheet-form material in a fixed position relative to the head portion 42 of the fastener device 40 such that a first side surface of the sheet-form material faces the article. The fastener members 48 are each pivotally movable from an open position to a fastening position to contact with a second, opposing side surface of the sheet-form material to hold said sheet-form material in said fixed position. Each fastener member 48 may comprise a planar flap 49 which extends downwardly from a respective pivot point 50A, B with the head portion 42 when in its open position as shown in FIG. 4. The pivot points 50A, B are preferably positioned at edges of a base part 42B of the head portion 42. The fastener members 48 are preferably formed integrally with the head portion 42. The fastener device 40 may be formed of a plastics material. The plastics material is preferably a mouldable thermoplastics material such as polypropylene. As such, the fastener device 40 can be formed as a single integral device by moulding. Each of the fastener members 48 may include a horizontally extending shoulder member 54 adjacent a respective pivot point 50A, B of the flaps 49. The function of the shoulder members 54 and the method of using the fastener device 40 is more fully described below.

FIGS. 5A to C are respectively a first side view, a second side view and a bottom view of a second embodiment of a fastener device 60 in accordance with the invention. In like manner to the fastener device 40 of FIG. 4, the fastener device 60 of FIGS. 5A to C is preferably formed from a plastics material as a single, integral device. It also has a head portion 62 for attaching to an article, but the head portion 62 includes a pin 63 extending upwardly (as viewed in FIG. 5A) from an upper surface 62A of the head portion 62. The pin 63 is adapted to be inserted into a hole provided in the article by screwing, riveting, friction fit, bayonet type fitting, or the like. Preferably, as shown in FIGS. 5A to C, the pin 63 has an upper screw-threaded portion 63A adapted to screw-threadedly engage in a screw-threaded hole in the article to thereby attach the fastener device 60 to the article. The pin 63 is preferably formed integrally with the head portion 62.

The fastener device 60 also has two fastener members 68 for holding a sheet-form material in a fixed position relative to the head portion 62. The fastener members 68 are each pivotally movable from an open position to a fastening position to contact with a second, opposing side surface of the sheet-form material to hold said sheet-form material in said fixed position. Each fastener member 68 may comprise a planar flap 69 which extends downwardly from a respective pivot point 70A, B with the head portion 62 when in its open position as shown in FIG. 5A. In FIGS. 5B and C, the flaps 69 are shown in their horizontal fastening positions. The pivot points 70A, B are preferably positioned at edges of a base part 62B of the head portion 62. Each of the fastener members 68 may include a horizontally extending shoulder member 74 adjacent a respective pivot point 70A, B of the flap 69 of the fastener member 68 is in its open position.

The pin 63 may have a cylindrical base part 63B which has a diameter greater than that of the pin 63, but less than that of the head portion 62. In use, the cylindrical base part 63B of the pin 63 is adapted to be inserted into a lower part of an aperture in a wall of an article and preferably such that it forms a snug fit with said lower part of the aperture to thereby strengthen the connection between the fastener device 60 and the article against transverse shocks during rough handling of a packaged article. The width or diameter of the head portion 62 is preferably at least twice that of the pin 63.

As shown more clearly in FIGS. 5B and C, the head portion 62 of the fastener device 60 may one or more planar tabs 76 extending horizontally from the upper surface 62A of the head portion 62 where said one or more tabs 76 extend beyond the width of the head portion 62. The tabs 76 preferably extend at right angles to the fastener members 68 as more clearly seen in FIGS. 5B and C when the fastener members 68 are in their horizontal fastening positions.

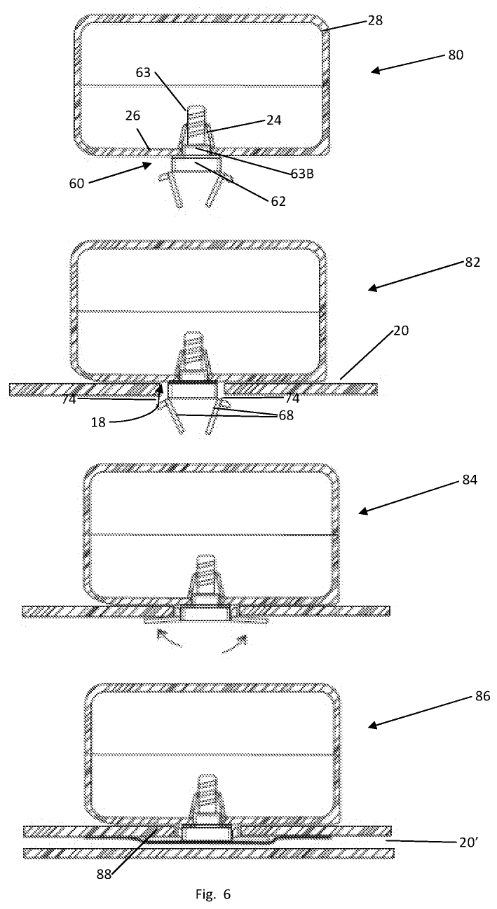

FIG. 6 shows a series of steps for connecting a fastener device according to any of the embodiments of the invention to an article such as a toy and to sheet-form packaging material in accordance with a first method of the invention. Whilst FIG. 6 illustrates the first method with respect to the fastener device 60 of FIGS. 5A to C, it will be understood that this method is applicable to any embodiment of the fastener device herein described with suitable changes to account for any structural differences.

A first step 80 of the method is attaching the fastener device 60 to an article such as a toy 28. In this instance, the pin 63 of the fastener device 60 is screw-threadedly engaged in hole 24 provided in a wall 26 of the toy 28. However, the method may include any means of attaching the fastener device to the wall 26 or a surface of the wall 26 of the toy 28. It will be seen that in step 80, the fastener device 60 is fixedly attached to the toy 28 without the presence of the sheet-form packaging material 20. Therefore, whether step 80 is performed manually or by machine, there are only two holding positions required, one for the toy 28 and one for the fastener device 60. It will also be seen that the cylindrical base part 63B of the pin 63 is received snugly into a bottom part of the hole 26 adjacent the wall 26. The fact that the head portion 62 has a larger diameter than the cylindrical base part 63B enables a much stronger connection to be formed between the fastener device 60 and the toy 28 which improves its resistance to transverse shear stress.

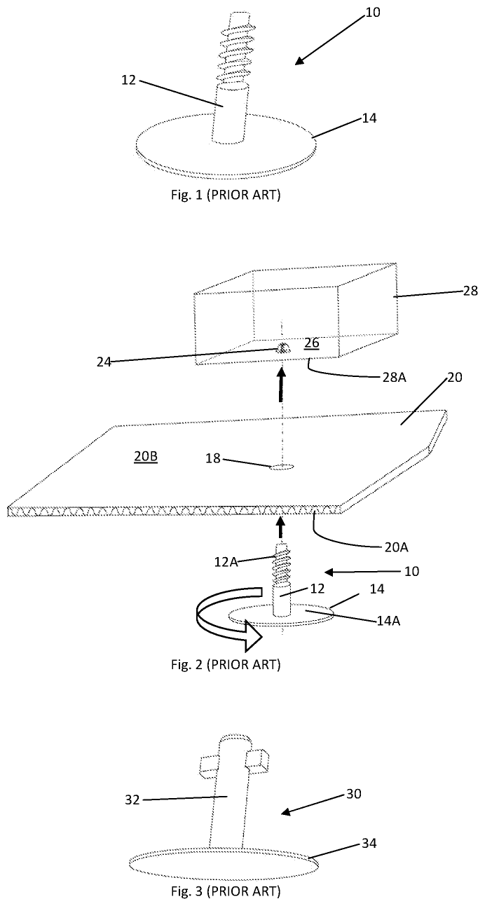

In a second step 82, a part or all of the head portion 62 of the fastener device 60 is received or inserted into an aperture 18 of the packaging material 20. In this method, the aperture 18 is sufficiently large as to allow the fastener members 68 (in their open positions) and their shoulder members 74 to pass through the aperture 18 with some clearance. It will be observed that the head portion 62 of the fastener device 60 is introduced to the aperture 18 of the packaging material 20 from a first, i.e. top, side of the packaging material 20 in contrast to the known devices of FIGS. 1 and 3 where the fastener device is introduced to the aperture in packaging material from an underside of said packaging material. Furthermore, it is will also be observed that, as the fastener device 60 is already fixedly attached to the toy 28, step 82 requires only two holding positions, one for the already attached fastener device 60 and toy 28 and one for the packaging material 20. Thus, manual or machine manipulation of the packaging material 20 when being connected with the fastener device 60 and toy 28 is simplified.

In a next step 84, the fastener members 68 are pivotally moved from their downwardly extending open positions, either manually or by machine, to their horizontal fastening positions as shown. Where the fastener members 68 include shoulder members 74, the shoulder members swing into spaces between the inner periphery of the aperture 18 and a side surface of the head portion 62 to thereby improve the fit of the fastener device 60 in the aperture 18 and reduce or prevent horizontal shear movement of the fastener device 60 within the aperture 18. Upper surfaces of the fastener members 68 (when viewed in their horizontal fastening positions) may be provided with an adhesive layer to fix said fastener members 68 to an underside surface of the packaging material 20.

In a final, although optional, step 86, a layer of adhesive tape 88 may be applied across the base of the fastener device 60 and extend over parts of the underside surface of the packaging material 20 to secure the fastener device 60 in place relative to the packaging material 20. Also, a second layer 20′ of packaging material may be employed as a back cover of the packaged toy 28 to hide the fastener device 60 from view and prevent it from being tampered with.

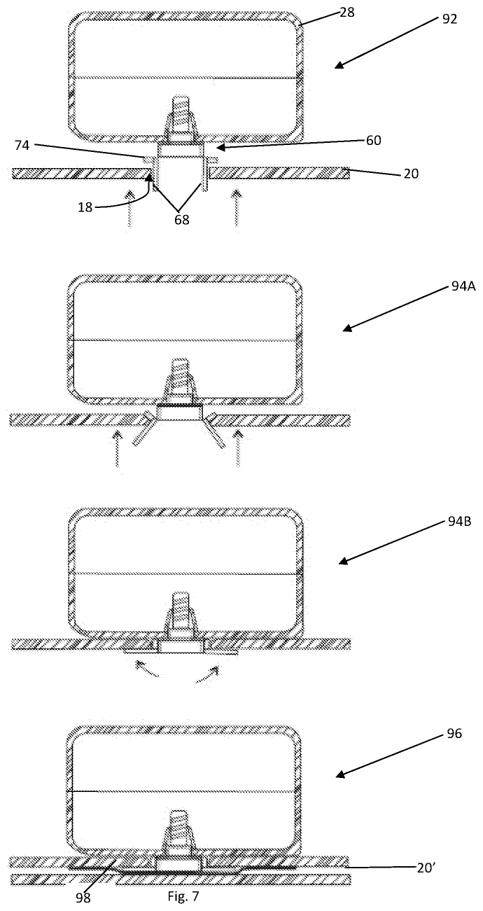

FIG. 7 shows a series of steps for connecting a fastener device for those embodiments of the invention where the fastener members include shoulder members as hereinbefore described.

A first step of the second method is not illustrated in FIG. 7 as it is identical to step 80 of FIG. 6 in that it comprises the first step of attaching the fastener device 60 to a toy 28 in the same manner as step 80 and with the same advantages.

In a second step 92, the fastener device 60 is introduced manually or by machine to the aperture 18 of the packaging material 20. In this method, the aperture 18 is sufficiently large as to allow the fastener members 68 (in their open positions) to pass through the aperture 18 but not so large as to allow the shoulder members 74 to pass through the aperture 18. The method may comprise moving the packaging material 20 towards the fastener device 60 or vide-versa.

In a first part 94A of a next step 94, the fastener device 60 is further inserted into the aperture 18 so that the upper surface of the packaging material 20 engages the shoulder members 74. Continued insertion of the fastener device 60 into the aperture 18 results in the packaging material 20 urging the fastener members 68 to pivotally move from their original downwardly extending open positions towards their horizontal fastening positions.

A second part 94B of the next step 94 shows the situation where the head portion 62 of the fastener device 60 has been received in the aperture 18, the fastener members 68 have reached their fastening positions and the shoulder members 74 have swung into the spaces between the inner periphery of the aperture 18 and a side surface of the head portion 62.

Upper surfaces of the fastener members 68 (when viewed in their horizontal fastening positions) may be provided with an adhesive layer to fix said fastener members 68 to an underside surface of the packaging material 20.

In a final, although optional, step 96, a layer 98 of adhesive tape may be applied across the base of the fastener device 60 and parts of the underside surface of the packaging material 20. Also, a second layer 20′ of packaging material may be employed as a back cover of the packaged toy 28.

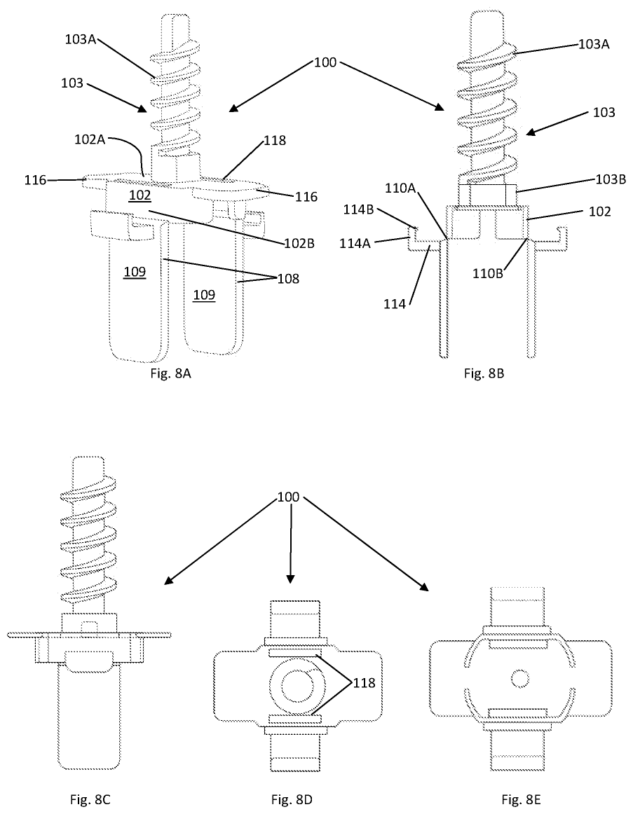

FIGS. 8A to E are respectively a perspective view, a first side view, a second side view, a top view and a bottom view of a third, preferred embodiment of a fastener device 100 in accordance with the invention. In like manner to the fastener device 60 of FIGS. 5A to C, the fastener device 100 of FIGS. 8A to E is preferably formed from a plastics material as a single, integral device. It also has a head portion 102 for attaching to an article. The head portion 102 includes a pin 103 extending upwardly (as viewed in FIGS. 8A to C) from an upper surface 102A of the head portion 102. The pin 103 is adapted to be inserted into a hole provided in the article by screwing, riveting, friction fit, bayonet type fitting, or the like. Preferably, as shown in FIGS. 8A to E, the pin 103 has an upper screw-threaded portion 103A adapted to screw-threadedly engage in a screw-threaded hole in the article to thereby attach the fastener device 100 to the article. The pin 103 is preferably formed integrally with the head portion 102. The fastener device 100 also has two fastener members 108 for holding a sheet-form material in a fixed position relative to the head portion 102. The fastener members 108 are each pivotally movable from an open position to a fastening position to contact with a second, opposing side surface of the sheet-form material to hold said sheet-form material in said fixed position. Each fastener member 108 may comprise a planar flap 109 which extends downwardly from a respective pivot point 110A, B with the head portion 102 when in its open position as shown in FIGS. 8A to C. The pivot points 110A, B are preferably positioned at edges of a base part 102B of the head portion 102. Each of the fastener members 108 includes a horizontally extending shoulder member 114 adjacent a respective pivot point 110A, B of the flap 109 of the fastener member 108. Each horizontally extending shoulder member 114 comprises an “L” shaped member with a short part 114A of the “L” shaped member extending upwardly (as viewed in FIGS. 8A to C) and each of said short parts 114A of the “L” shaped members having a hooked tip 114B at their distal ends. As more clearly seen in FIG. 8D, locking slots 118 are provided in the upper surface 102A of the head portion 102 at appropriate locations such that the hooked tips 114B of the short parts 114A of the “L” shaped members lock into respective ones of said slots 118 when the fastener members 108 are pivotally moved to their fastening positions. The use of the hooked tips 114B negates the need for providing upper surfaces of the fastener members with an adhesive layer and/or the need to apply adhesive tape over the fastener member 100 when locked into position with the packaging material 20.

The pin 103 may have a cylindrical base part 103B which has a diameter less than that of the head portion 102. The width or diameter of the head portion 102 is preferably at least twice that of the pin 103.

The head portion 102 may have one or more planar tabs 116 extending horizontally from the upper surface 102A of the head portion 102 where said one or more tabs extend beyond the width of the head portion 102. The tabs 116 preferably extend at right angles to the fastener members 108.

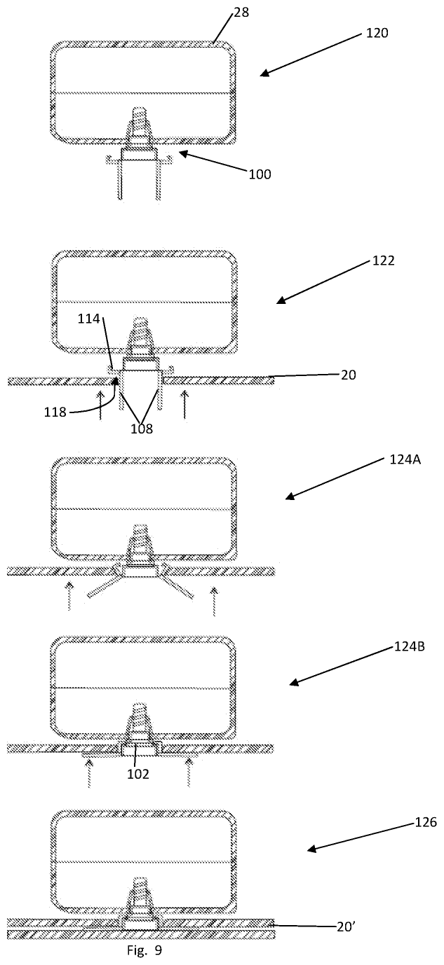

FIG. 9 shows a series of steps of connecting the fastener device 100 of FIGS. 8A to E to an article such as a toy 28 and to sheet-form packaging material 20 in accordance with a third method of the invention.

A first step 120 of the third method comprises attaching the fastener device 100 to a toy 28 in a same manner as step 80 of the first method.

In a second step 122, the fastener device 100 is introduced manually or by machine to the aperture 18 of the packaging material 20. In this method, the aperture 18 is sufficiently large as to allow the fastener members 108 (in their open positions) to pass through the aperture 18 but not so large as to allow the shoulder members 114 to pass through the aperture 18.

In a first part 124A of a next step 124, the fastener device 100 is further inserted into the aperture 18 so that the upper surface of the packaging material 20 engages the shoulder members 114. Continued insertion of the fastener device 100 into the aperture 18 results in the packaging material 20 urging the fastener members 108 to pivotally move from their original open positions towards their fastening positions.

A second part 124B of the next step 124 shows the situation where the head portion 102 of the fastener device 100 has been received in the aperture 18, the fastener members 108 have reached their fastening positions and the shoulder members 114 have swung into the spaces between the inner periphery of the aperture 18 and a side surface of the head portion 102. Furthermore, the hooked tips 114B of the shoulder members 114 have locked into their respective slots 118 in the head portion 102.

In a final, although optional, step 126, a second layer 20′ of packaging material may be employed as a back cover of the packaged toy 28.

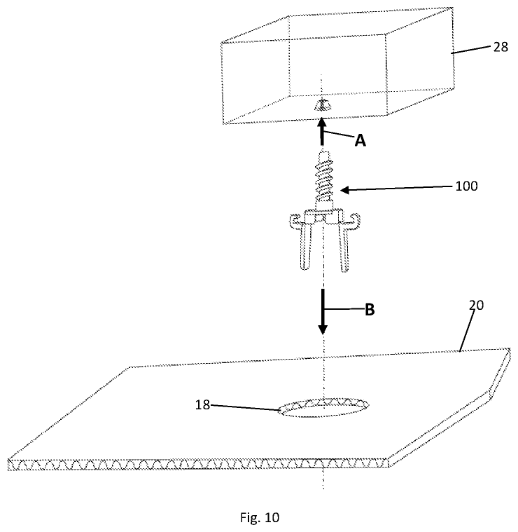

FIG. 10 illustrates the two main steps of all of the methods of the invention with respect to the fastener device 100 of FIGS. 8A to E. A first step denoted by arrow A is to attach the fastener device 100 to the toy 28. The second step denoted by arrow B is to connect the packaging material 20 to the already attached toy 28 and fastener device 100.

In all embodiments of the invention, the fastener device is adapted to be releasably attached to the article.

In the methods of the invention, it is preferred that the diameter of the aperture in the packaging material is at least 8 mm, preferably at least 10 mm and more preferably at least 15 mm. This greatly reduces horizontal shear stress on the fastener device and particularly the pin of the fastener device that might result through rough handling of a packaged article.

The known fastener devices of FIGS. 1 and 3 cannot provide the novel horizontally extending support tabs on the head portion of the fastener device as herein claimed, because the pins of the known fastener devices are inserted into the aperture of the packaging material from an underside and thus the provision of such support tabs would prevent the known fastener devices being connected to the packaging material and article.

The improvements provided by the embodiments of the fastener device of the invention and the methods of the invention render said methods more susceptible to machine, i.e. automatic, implementation to reduce manual labor and costs.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. A method of fastening an article to a sheet-form material, the sheet-form material having an aperture for receiving a fastener device, the method comprising the steps of:
attaching the fastener device to the article;
inserting part of the fastener device into the aperture of the sheet-form material from a first side surface of the sheet-form material; and
pivotally moving a fastener member of the fastener device from an open position to a fastening position to contact with a second, opposing side surface of the sheet-form material to hold said sheet-form material in a fixed position relative to the fastener device.

2. The method of claim 1, wherein the fastener member is pivotally moved from its open position to its fastening position through contact with the sheet-form material when the part of the fastener device is received in the aperture of the sheet-form material.

3. The method of claim 1, wherein the fastener member locks into position when it reaches its fastening position.

4. The method of claim 3, wherein the fastener member locks into position through engagement of a part of the fastener member with a head portion of the fastener device.

5. The method of claim 1, wherein the fastener member is pivotally connected to the fastener device.

6. The method of claim 1, wherein the fastener member is integrally formed with the fastener device.

7. A fastener device for connecting an article to a sheet-form material, said fastener device comprising:
a part for attaching to the article; and
a fastener member for holding said sheet-form material in a fixed position relative to the part of the fastener device such that a first side surface of the sheet-form material faces the article, the fastener member being pivotally movable from an open position to a fastening position to contact with a second, opposing side surface of the sheet-form material to hold said sheet-form material in said fixed position.

8. The fastener device of claim 7, wherein the fastener member is configured to lock into position when it reaches its fastening position.

9. The fastener device of claim 8, wherein the fastener member is configured to lock into position through engagement of a part of the fastener member with a head portion of the fastener device.

10. The fastener device of claim 7, wherein the fastener member is pivotally connected to the fastener device.

11. The fastener device of claim 7, wherein the fastener member is integrally formed with the fastener device.

12. The fastener device of claim 7, wherein the fastener device includes a pin which attaches to the article.

13. The fastener device of claim 12, wherein the pin attaches to the article by any one of: a friction fit with a hole in the article; a screw-threaded engagement with a screw-threaded hole of the article; and a bayonet type connection with a hole of the article.

14. The fastener device of claim 12, wherein the width of a head portion is at least twice the width of the pin.

15. The fastener device of claim 7, wherein the fastener member comprises a planar flap which extends downwardly from a pivot point with the fastener device when in its open position.

16. The fastener device of claim 15, wherein the fastener member flap includes a horizontally extending shoulder member adjacent the pivot point with the fastener device when the flap is in its open position.

17. The fastener device of claim 16, wherein the shoulder member of the flap extends sufficiently outwardly in a horizontal direction when the flap is in its open position such that it is engaged by the sheet-form material when the part of the fastener device is received in the aperture of the sheet-form material to thereby pivotally move the flap from its open position to its fastening position.

18. The fastener device of claim 7, wherein a head portion has one or more planar tabs extending horizontally from an upper end thereof where said one or more tabs extend beyond the width of the head portion.

19. The fastener device of claim 18, wherein the one or more horizontally extending planar tabs extend at a right angle to the fastener member when the fastener member is in its fastening position.
